(19) United States
(12) Patent Application Publication
(10) Pub. No.: US 2006/0003659 A1
(43) Pub. Date: Jan. 5, 2006

(54) Aramid paper laminate

(76) Inventors: Dariusz Wlodzimierz Kawka, Midlothian, VA (US); David Wayne Anderson, Chester, VA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/150,568

(22) Filed: Jun. 10, 2005

Related U.S. Application Data
(62) Division of application No. 10/460,435, filed on Jun. 10, 2003, now abandoned.
Application No. 10/460,435 is a continuation-in-part of application No. 10/261,850, filed on Oct. 1, 2002, now abandoned.

(51) Int. Cl. B32B 15/14; B32B 5/26; B29C 47/00; B28B 3/20; B29C 67/20; B32B 27/12

(52) U.S. Cl. 442/381; 442/394; 264/176.1; 264/175

(57) ABSTRACT

A laminate of aramid nonwoven sheet and polyester resin having an overall thickness of 5 to 25 mils (0.13 to 6.4 mm) and having an elongation at break of at least 40% in both the cross and machine direction and an average tear load in excess of 1.5 pounds-force (6.7 newtons) in both the cross and machine directions.

### RELATED APPLICATION

The present patent application is a continuation-in-part of Ser. No. 10/261,850 filed Oct. 1, 2002.

### BACKGROUND OF THE INVENTION

The present invention is directed to a improved laminate of aramid paper and a polyester polymer layer, preferably a laminate of two aramid papers separated by a polyester polymer layer.

Japanese Patent Publication 8-99389 discloses formation of a laminate sheet of m-aramid paper and a polyester film employing calendering and rapid cooling of the formed laminate.

British Patent 1,486,372 discloses a metallic layer adhered to a nonwoven web of a blend of different staple fibers which have been compacted and held together with a matrix of film-forming high molecular polymeric binder material.

Hendren et al. U.S. Pat. No. 5,320,892 discloses a laminate for honeycomb structures formed from a core containing poly(m-phenylene isophthalamide) fibrids and outside layers of a floc and fibrids of poly(m-phenylene isophthalamide).

Ootuka et al. U.S. Pat. No. 5,948,543 discloses formation of a laminate base material of aromatic polyamide fiber non-woven fabric formed from fibers of para-aramid and meta-aramid bonded with a resin binder.

Laminates made from aramid sheet(s) or paper(s) and polyester polymer layer(s) are useful in transformers wherein the laminate serves as dielectric insulation material. Any improvement in the internal adhesion of the laminate or the tear or elongation at break properties of such laminates is desirable.

### SUMMARY OF THE INVENTION

The present invention is directed to a laminate of nonwoven aramid sheet and polyester resin having an overall thickness of 5 to 25 mils (0.13 to 0.64 mm), preferably 5 to 20 mils (0.13 to 0.51 mm) and having an elongation at break of at least 40% in both the cross and machine direction and an average tear load in excess of 1.5 pounds-force (6.7 newtons) in both the cross and machine directions. The thickness of the resin layer in the laminate is preferably greater than the thickness of any individual nonwoven sheet in the laminate. It is preferred the nonwoven aramid sheet be a paper and that the paper include the aramid, poly(metaphenylene isophthalamide). The preferred polyester resin used in the laminate is poly(ethylene terephthalate) and may contain other comonomers or branching agents.

### BRIEF DESCRIPTION OF THE DRAWINGS

FIG. 1 is a simplified representation of an extrusion lamination process useful in making the laminates of this invention.

FIG. 2 is a representation of the improvement in initial tear resistance of the extrusion laminates of this invention over prior art adhesion laminates.

### DETAILED DESCRIPTION OF THE INVENTION

Laminates made from aramid sheets or papers and polyester resin films have been used in transformers wherein the laminate serves as dielectric insulation material. It is desired that such insulative laminates have a combination of physical properties which are especially suited for the needs of transformer manufacturers. These properties include in addition to insulative properties, other mechanical properties which include initial tear resistance (as measured by elongation at break) and high resistance to tear propagation (as measured by average tear load). These properties are especially useful in evaluating insulative laminates because in the manufacture of transformers there is the likelihood the insulative laminate will be damaged during assembly.

It has been found that the elongation and tear properties of aramid insulative laminates can be improved by replacing the form of the polyester that is used in the laminates. In particular, it has been found that a laminate made with a molten polyester resin has improved elongation and tear properties over laminates made with films.

Typically, laminates used in the prior art for electrical insulation have utilized polyester film. Since polyester film by itself does not have good adhesion to aramid paper because of the smooth surface of the aramid paper, adhesives have been used to attach the films to the aramid paper. The films were attached to the aramid paper by first coating an adhesive onto the film and then laminating the coated film onto the aramid paper at high temperature. It is believed that the use of polyester in film form in the laminate limits the elongation and tear properties of the final laminate, in that typical processes for forming a solid film impart a degree of crystallinity and dimensional stability into the polyester layer. This is believed to reduce the flexibility of the final laminate.

The laminates of this invention preferably utilize aramid paper. As employed herein the term paper is employed in its normal meaning and it can be prepared using conventional paper-making processes and equipment and processes. Aramid fibrous material such as fibrids and short fibers can be slurried together to from a mix which is converted to paper such as on a Fourdrinier machine or by hand on a handsheet mold containing a forming screen. Reference may be made to Gross U.S. Pat. No. 3,756,908 and Hesler et al. U.S. Pat. No. 5,026,456 for processes of forming aramid fibers into papers. Generally, once aramid paper is formed it is calendered between two heated calendering rolls with the high temperature and pressure from the rolls increasing the bond strength of the paper. Calendering aramid paper in this manner also decreases the porosity of the of the paper and it is believed this results in poorer adhesion of the paper to polymer layers in laminates.

The thickness of the aramid paper is not critical and is dependent upon the end use of the laminate as well as the number of aramid layers employed in the final laminate. Although the present invention may employ two layers, i.e. one aramid layer and one polymer layer, and preferably employs a three layers, i.e. two aramid paper layers and one polymer layer, it is understood that there is no upper limit in the number of layers or other materials which can be present in the final article. However, an overall upper limit thickness of the laminate will be present as previously set forth.

As employed herein the term aramid means polyamide wherein at least 85% of the amide (—CONH—) linkages are attached directly to two aromatic rings. Additives can be used with the aramid and, up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride of the aramid. In the practice of this invention, the aramids most often used are: poly(paraphenylene terephthalamide) and poly(metaphenylene isophthalamide) with poly(metaphenylene isophthalamide) being the preferred aramid.

The preferred polyester resin, i.e. polymer applied to the aramid paper in this invention is polyethylene terephthalate (PET). The PET used may include a variety of comonomers, including diethylene glycol, cyclohexanedimethanol, poly(ethylene glycol), glutaric acid, azelaic acid, sebacic acid, isophthalic acid, and the like. In addition to these comonomers, branching agents like trimesic acid, pyromellitic acid, trimethylolpropane and trimethyloloethane, and pentaerythritol may be used. The PET may be obtained by known polymerization techniques from either terephthalic acid or its lower alkyl esters (e.g. dimethyl terephthalate) and ethylene glycol or blends or mixtures of these. Another polyester resin useful in this invention is polyethylene napthalate (PEN). PEN may be obtained by known polymerization techniques from 2,6-napthalene dicarboxylic acid and ethylene glycol.

The preferred calendered aramid paper used in this invention has been made by differential calendering. Such papers are made by calendering the papers in a single calendering step between heated rolls having different temperatures, or the papers may be made by first calendering one surface of the sheet at one temperature and then the opposing surface with a second temperature. This difference in temperature directly results in a difference in the porosity of opposite surfaces of the aramid paper, which translates to improved adhesion of the molten resin to the aramid paper. A temperature difference of at least 20 degrees centigrade is necessary to obtain the advantages of the differential calendaring process, with temperature differences of at least 50 to 100 degrees centigrade, or more, being preferred. It is understood that the temperature in the heated rolls may be below the glass transition temperature of the aramid components in the paper. However, in a preferred mode at least one of the heated rolls will be at or above the glass transition temperature of the aramid.

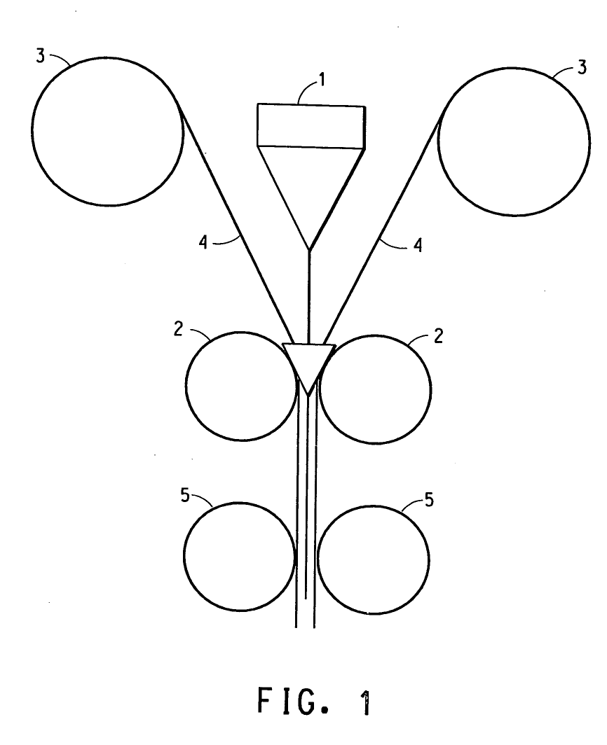

While not intended to be limiting, one method of making the laminates of this invention is by extruding molten polymer between two calendered aramid papers followed by pressing and quenching to form the laminate. The molten resin can be extruded onto the aramid sheets in any number of ways. For example, the resin may be extruded onto one calendered aramid sheet and then covered with a second aramid sheet and then laminated using a press or laminating rolls. Referring to FIG. 1, in a preferred method, the molten resin is supplied to a slotted die 1 from an extruder. The slotted die is oriented so that a sheet of molten resin is extruded in a downward fashion to a set of horizontal laminating rolls 2. Two supply rolls of aramid paper 3 provide two separate webs 4 of aramid paper to the laminating rolls and both webs and the sheet of molten resin all meet in the nip of the laminating rolls with the resin positioned between the two webs. The rolls consolidate the webs and resin together; the consolidated laminate is then quenched using a set of cooled rolls 5. Alternatively, the horizontal laminating rolls 2 may be cooled to both consolidate and quench the laminate. The laminate may then be cut to appropriate size as needed for the application.

In another embodiment of this invention, the combination of molten polymers may extruded in a manner which layers the different polymers between the two aramid papers. For example, the polymer layer could consist of three layers such as, in order, a layer of PET polymer having a first intrinsic viscosity, a layer of PET polymer having a second intrinsic viscosity, and a third layer of PET polymer having the same intrinsic viscosity as the first layer. In this manner a PET polymer having more affinity to aramid sheets can be employed to incorporate a PET polymer having less affinity to aramid sheets into the laminate.

The laminates of this invention have a thickness of from 5 to 25 mils, such as 5 to 20 mils, and have an elongation at break of at least 40% in both the cross- and machine-direction. Further, these laminates have an average tear load in excess of 1.5 pounds-force in both the cross and machine directions. It is preferred such laminates have resin thickness greater than any one nonwoven sheet in the laminate.

In the following examples all parts and percentages are by weight unless otherwise indicated. Initial tear resistance was measured via elongation at break per ASTM D004. Tear propagation resistance was measured via average tear load by ASTM D938.

### EXAMPLE

This example illustrates the properties of the laminates of this invention made by extrusion lamination, versus laminates made by adhesive lamination. The extrusion laminates were made as follows. Aramid paper comprised of 45% poly(m-phenylene isopthalamide) floc and 55% poly(m-phenylene isopthalamide) fibrids was made using conventional Fourdrinier paper making processes and equipment. The paper was then calendered at 800 pli (1400 n/cm) between two rolls operating at different surface temperatures, specifically 360 degree centigrade and 250 degrees centigrade, to make differential calendered papers for lamination. Polymer was applied to the more porous surfaces of the aramid sheets by extrusion lamination of poly(ethylene terephthalate) (PET) polyester polymer between the two papers. These extrusion laminates were compared to commercially available adhesive laminates used in electrical insulation containing a polyester film adhesively laminated between two Nomex® Type 416 aramid papers.

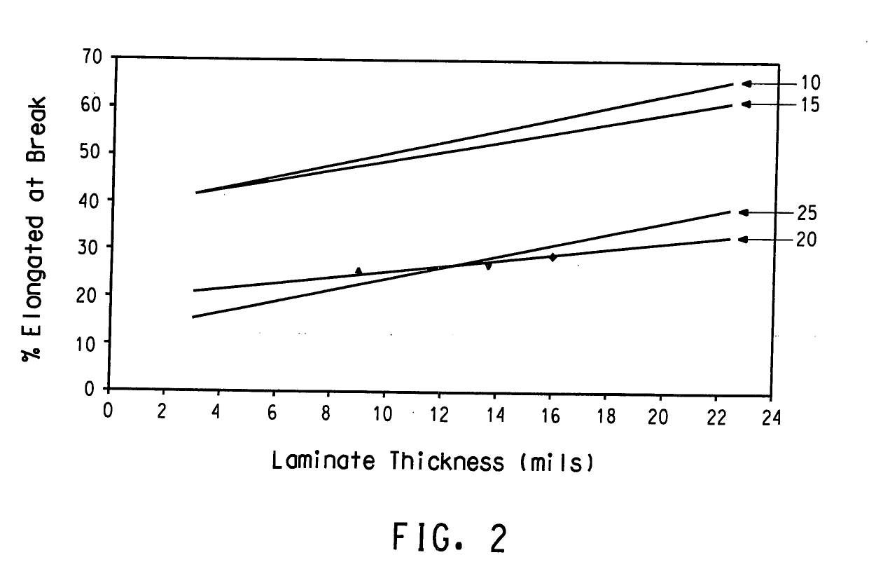

The resulting data illustrated that laminates of this invention made by extrusion lamination had both improved initial tear resistance, as measured by having an elongation to break of greater than 40% in both directions, along with improved tear propagation resistance, as measured by having an average tear load of greater than 1.5 lb-force (6.7 newtons). As used below, EL stands for extrusion lamination, AL stands for adhesive lamination, MD stands for machine direction, and XD stands for the cross or traverse direction. FIG. 2 illustrates the improvement in elongation to break for these laminates, with the lines 10 and 15 representing the MD and XD values for the extrusion laminates and lines 20 and 25 representing the MD and XD values for adhesive laminates.

| | | Type of Laminate | | | | | |
|---|---|---|---|---|---|---|---|
| | | AL | EL | AL | EL | AL | EL |
| Aramid Sheet Thickness | (mils) | 3 | 3 | 3 | 3 | 3 | 3 |
| | (mm) | 0.076 | 0.076 | 0.076 | 0.076 | 0.076 | 0.076 |
| Polymer Thickness | (mils) | 5 | 5 | 7.5 | 7.5 | 10 | 10 |
| | (mm) | 0.127 | 0.127 | 0.191 | 0.191 | 0.254 | 0.254 |
| MD Elongation at Break | (%) | 25 | 50 | 28 | 52 | 31 | 55 |
| XD Elongation at Break | (%) | 26 | 52 | 27 | 54 | 29 | 58 |
| MD Average Tear Load | (lb-f) | 1.1 | 1.9 | 1.2 | 2.2 | 1.9 | 3.5 |
| | (N) | 4.9 | 8.5 | 5.3 | 9.8 | 8.5 | 15.6 |
| XD Average Tear Load | (lb-f) | 1.4 | 3.0 | 1.7 | 3.3 | 2.0 | 4.8 |
| | (N) | 6.2 | 13.4 | 7.6 | 14.7 | 8.9 | 21.4 |

MD is machine direction
XD is cross direction

1-12. (canceled)

13. A method of making a laminate useful in electrical insulation, comprising:
a) providing two aramid nonwoven sheets to the nip between a pair of rolls,
b) extruding a molten polyester polymer between the two aramid sheets prior to or into the nip between the pair of rolls,
c) consolidating the aramid sheets and molten polymer between the rolls to form an unquenched laminate, and
d) cooling the unquenched laminate-.
wherein the laminate has an elongation at break of at least 40% in both cross and machine directions and an average tear load in excess of 1.5 pounds-force (6.7 newtons) in both the cross and machine directions.

14. The method of claim 13 wherein the laminate is consolidated and quenched to an overall thickness in a range from 5 to mils 20 (0.13 to 0.51 mm).

15. The method of claim 13 wherein the molten polyester polymer is extruded through a slot die.

16. A method of making a laminate useful in electrical insulation, comprising:
a) providing two aramid sheets to the nip between a pair of rolls,
b) extruding a molten polyester polymer between the two aramid sheets prior to or into the nip between the pair of rolls,
c) consolidating and quenching the aramid webs and molten polymer between the rolls to form the laminate-.
wherein the laminate has an elongation at break of at least 40% in both cross and machine directions and an average tear load in excess of 1.5 pounds-force (6.7 newtons) in both the cross and machine directions.

17. The method of claim 16 wherein the laminate is consolidated and quenched to an overall thickness in a range from 5 to 20 mils (0.13 to 0.51 mm).

18. The method of claim 16 wherein the molten polyester polymer is extruded through a slot die.

19. The method of claim 13 wherein the polyester polymer comprises poly(ethylene terephthalate).

20. The method of claim 13 wherein the polyester polymer comprises poly(ethylene naphthalate).
